(19) United States
(12) Patent Application Publication
(10) Pub. No.: US 2026/0320407 A1
(43) Pub. Date: Oct. 15, 2026

(54) REASONING-ENHANCED SELF-TRAINING FOR CUSTOMIZED OUTPUTS

(71) Applicant: GDM Holding LLC, Mountain View, CA (US)

(72) Inventors: Alireza Salemi, Amherst, MA (US); Cheng Li, Mountain View, CA (US); Weize Kong, Mountain View, CA (US); Tao Chen, San Mateo, CA (US); Zhuowan Li, Mountain View, CA (US); Mingyang Zhang, San Jose, CA (US); Qiaozhu Mei, Ann Arbor, MI (US); Michael Bendersky, Cupertino, CA (US)

(21) Appl. No.: 19/346,036

(22) Filed: Sep. 30, 2025

Related U.S. Application Data
(60) Provisional application No. 63/702,150, filed on Oct. 1, 2024.

(51) Int. Cl. G06N 3/096; G06N 3/0475

(52) U.S. Cl. CPC G06N 3/096; G06N 3/0475

(57) ABSTRACT

Methods, systems, and apparatus, including computer programs encoded on a computer storage medium, for training a token generation neural network to generate outputs. In one aspect, a system comprises a method for obtaining a plurality of training examples, each comprising a request, an input context for a respective entity corresponding to the request, and a ground truth output for the respective entity, generating one or more candidate outputs for each of the training examples using the token generation neural network, determining a quality score based on a similarity between each of the candidate outputs and the ground truth output, selecting a subset of the candidate outputs based on the quality scores, and updating values of a set of parameters of the token generation neural network using the selected subset of candidate outputs for each of the plurality of training examples.

### CLAIM OF PRIORITY

This application claims priority under 35 USC § 119(e) to U.S. Patent Application Ser. No. 63/702,150, filed on Oct. 1, 2024, the entire contents of which are herein incorporated by reference.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system that can train a token generation neural network to generate outputs conditioned on an input context in response to a request to generate an output for an entity, e.g., a user, a group of users, an organization, etc., by reasoning over the input context.

In this specification, conditioning the output on the input context refers to generating an output based on one or more data items included in an entity-specific context for the request. For example, the data items in the entity-specific context can reflect the entity's implicit preferences for how to respond to the request.

In particular, the input context can include one or more of textual data items, visual data items, computer code data items, or audio data items. The system can train the token generation neural network by conditioning on a summary of relevant aspects of the input context to generate a more tailored and relevant output that aligns with the entity's expectations and preferences. In some cases, the system can be used to generate a personalized output for the entity, e.g., an output that is customized for the entity based on the input context.

The system can have trained the token generation neural network using iterative self-training. More specifically, during training, the system can generate one or more candidate outputs for a set of training examples, each including a ground truth output (e.g., from the entity), and can determine a quality score to select a subset, e.g., a proper subset, of the candidate outputs for training the token generation neural network. In particular, the candidate outputs can include (i) a candidate summary and (ii) a candidate output. During training, the system can instruct the token generation neural network to generate the candidate output conditioned on the candidate summary and can steer the training process by selecting candidate outputs for use in updating the token generation neural network that are similar to aground truth output provided in each training example.

In an example implementation, the system can train the token generation neural network—to generate personalized text for an entity. For example, the input context can include previous written text for the entity, e.g., emails, documents, messages. In this case, the system can train the token generation neural network to generate text conditioned on the input context to generate customized text tailored to the entity's writing style and preferences. In particular, the token generation neural network can improve the quality of the personalized text relative to a token generation neural network that has not been trained to generate personalized content.

In another example implementation, the system can train the token generation neural network to improve the maintainability of a codebase. For example, the input context can include code from a common codebase and the entity's style guide that promotes a level of consistency for the code in the common codebase. In this case, the system can train the token generation neural network to generate code conditioned on the input context to improve the maintainability of the codebase by promoting the consistency of the code style in the code base. In particular, training the token generation neural network to maintain the codebase can enhance the ability of the entity that manages the codebase to monitor changes to the codebase, e.g., by ensuring that they remain compliant with the style guide.

According to a first aspect there is provided a method for training a token generation neural network to generate outputs conditioned on an input request and an input context characterizing a corresponding entity, the method comprising, at each of a set of one or more iterations, obtaining a plurality of training examples for the iteration, each training example comprising a request, an input context for a respective entity corresponding to the request, and a ground truth output for the respective entity, for each of the plurality of training examples, generating, by processing an input comprising the request in the training example and the input context in the training example using the token generation neural network, one or more candidate outputs, each candidate output comprising a candidate summary of the input context and a candidate output conditioned on the candidate summary, and determining a quality score for each of the one or more candidate outputs based on a similarity between the candidate output and the ground truth output in the training example, selecting a subset of the candidate outputs based on the quality scores for the candidate outputs, and updating values of a set of parameters of the token generation neural network using the selected subset of candidate outputs for each of the plurality of training examples.

In some implementations, obtaining the plurality of training examples further comprises, for each training example, accessing a repository of first entity data items that are associated with the respective entity corresponding to the requests, and identifying k data items relevant to the request from the repository of first entity data items as the input context for the request.

In some implementations, identifying k data items relevant to the request further comprises identifying the k data items using a dense information retrieval model.

In some implementations, the input context comprises one or more of textual data items, visual data items, computer code data item, or audio data items.

In some implementations, the computer code data items are each selected from a common codebase.

In some implementations, generating one or more candidate outputs using the token generation neural network comprises, for each of the plurality of training examples, generating the one or more candidate outputs by processing the request and the input context using the token generation neural network at a first decoding temperature with an instruction to generate the candidate summary and the candidate output conditioned on the candidate summary.

In some implementations, each of the one or more candidate outputs comprises a sequence of output tokens generated by the token generation neural network.

In some implementations, the method further comprises, for each candidate output, using nucleus sampling to select the sequence of output tokens at the first decoding temperature.

In some implementations, the quality score does not depend on the candidate summary.

In some implementations, determining the quality score comprises generating a respective quality score for each candidate output by processing a scoring input comprising the candidate output and the ground truth output in the training example using a quality model.

In some implementations, the quality model is the token generation neural network or a second token generation neural network, and wherein the scoring input further comprises an instruction to evaluate a measure of similarity between the candidate output and the ground truth output.

In some implementations, selecting the subset of the candidate outputs based on the quality scores comprises selecting the subset of candidate outputs with respective quality scores that satisfy a threshold.

In some implementations, selecting the subset of the candidate outputs comprises selecting N candidate outputs with respective quality scores that satisfy a threshold.

In some implementations, updating values of the set of parameters of the token generation neural network using the selected subset of candidate outputs comprises, for each of the plurality of training examples, determining a respective discrepancy between each candidate output in the selected subset of candidate outputs for the training example and the ground truth output in the training example, for each of the plurality of training examples, generating a respective training example discrepancy by aggregating the respective discrepancies for each candidate output, generating a training iteration discrepancy by aggregating the respective training example discrepancies, and updating the values of the set of parameters of the token generation neural network to minimize a loss function that comprises a first term that measures the training iteration discrepancy.

In some implementations, generating a respective training example discrepancy by aggregating the respective discrepancies for each candidate output comprises generating respective weighted discrepancies by applying an importance weight to the discrepancy for each candidate output in accordance with the corresponding quality score for the candidate output, and generating the training example discrepancy by aggregating the respective weighted discrepancies for each candidate output.

In some implementations, the respective discrepancies measure a sequence-to-sequence loss over respective output tokens corresponding with each candidate output and ground truth tokens corresponding with the ground truth output.

In some implementations, the set comprises a plurality of iterations, and, for each iteration in the plurality of iterations after a first iteration, the generating one or more candidate outputs using the token generation neural network comprises generating one or more candidate outputs using values of the set of parameters of the token generation neural network determined at the preceding iteration.

In some implementations, the method further comprises, at a first iteration, for each of the plurality of training examples at each of a second set of iterations, generating a first summary by processing the request, the input context, and the ground truth output using the token generation neural network with an instruction to identify relevant aspects of the input context for the ground truth output, combining the first summary and the ground truth output as an expected output for the training example, generating, by processing an input comprising the request in the training example and the input context in the training example using the token generation neural network, a second summary of the input context and an output conditioned on the second summary with a (i) first instruction to generate the second summary for the first entity and (ii) a second instruction to generate the output conditioned on the second summary without considering the corresponding ground truth output, and updating the values of the set of parameters of the token generation neural network using the one or more generated outputs and the corresponding one or more expected outputs for the plurality of training examples.

In some implementations, updating the values of the set of parameters of the token generation neural network using the one or more generated outputs and the corresponding one or more expected outputs comprises updating the values of the set of parameters of the token generation neural network in accordance with minimizing a (i) first discrepancy between the respective generated second summaries and respective first summaries of the expected outputs and (ii) a second discrepancy between the respective generated outputs and the respective ground truth outputs of the expected outputs for each of the plurality of training examples.

In some implementations, the token generation neural network is a language processing neural network.

In some implementations, the token generation neural network is a vision language model.

In some implementations, the output is a long-form text output.

In some implementations, the output is a visual output.

In some implementations, the output is an audio output.

In some implementations, the output is a multimodal output comprising one or more of a textual output, visual output, or audio output.

In some implementations, each training example is associated with a respective entity.

In some implementations, the output conditioned on the context is a personalized output customized for the first entity, and wherein the candidate outputs are candidate personalized outputs.

In some implementations, the token generation neural network is utilized as an entity-specific personalization agent of the first entity.

According to a second aspect there is provided a method for performing a machine learning task, comprising receiving an input request, obtaining an input context for a first entity, and processing the input request and the input context using a trained token generation neural network to generate an output conditioned on the input context for the first entity, wherein the token generation neural network has been trained by operations comprising any of the aforementioned implementations of the method.

In some implementations, obtaining the input context for the first entity comprises receiving the input context for the first entity, or obtaining the input context from a repository of first entity data items associated with the first entity.

In some implementations, processing the input request using the trained token generation neural network to generate the personalized output further comprises generating a summary of the input context as a first subset of a sequence of output tokens and the personalized output as a second subset of the sequence of output tokens using the trained token generation neural network, wherein the output is conditioned on the summary.

According to a third aspect there is provided a method for performing a machine learning task, the method comprising receiving an input request, obtaining an input context characterizing a first entity, processing the input request and the input context using a token generation neural network to generate an output, wherein the token generation neural network has been trained to generate a summary of the input context characterizing the first entity in a first subset of a sequence of output tokens prior to generating the output in a second subset of a sequence of output tokens, and wherein the generation of the output by the token generation neural network is conditioned on the summary of the input context characterizing the first entity.

In some implementations, the token generation neural network has been trained to generate the input context characterizing an entity prior to the first entity using a plurality of training examples, wherein each training example comprises (i) a training input comprising a respective input request and a respective input context characterizing an entity different from the first entity, and (ii) a training output comprising a respective summary of the input context characterizing the entity different from the first entity, and, subsequently, an output responsive to the input request.

In some implementations, for one or more of the plurality of training examples, the summaries of the input context have been generated using a token generation neural network.

In some implementations, displaying the output to a user associated with the first entity.

In some implementations, the summary of the input context characterizing the entity is not displayed to the first entity.

Particular embodiments of the subject matter described in this specification can be implemented so as to realize one or more of the following advantages.

This system of this specification can provide for the tailored self-training of a token generation neural network to generate customized outputs conditioned on an input context. By training the token generation neural network to perform reasoning over the input context before generating an output, the system can guide the token generation neural network to evaluate relevant aspects of the input context that reflect the entity's implicit preferences, resulting in the generation of high-quality customized outputs for an entity, even for difficult customization tasks.

In particular, the system can guide the token generation neural network to generate high-quality training data using iterative self-training. Since multiple acceptable outputs for an entity can exist in a customization task, training on a single ground truth output is not sufficient. By selecting a subset of candidate outputs based on a quality score that characterizes the similarity of the candidate output to the ground truth output for the training example, the system of this specification can significantly reduce the computational burden of training. In more detail, since generally not all of the generated candidate outputs are selected for training, less memory is required to store less training examples, and fewer processor cycles are needed to carry out training with less training examples.

Furthermore, in some cases, using all of the generated candidate outputs for training can dilute the training process, since not all of the candidate outputs are not desirable to the entity. More specifically, using the less desirable candidate outputs for training can result in slower convergence and require training with more training iterations relative to training using a high-quality proper subset of candidate outputs that are selected using a quality score. By selecting the candidate outputs based on similarity to the available ground truth outputs, the system can train using higher-quality data and therefore guide the token generation neural network toward generating high-quality customized outputs for the entity in less iterations. Thus, the system can promote faster convergence of the token generation neural network in less training iterations than would be required relative to training using all candidate outputs, thereby further reducing the computational resources required for training since fewer processing iterations are necessary to train with less iterations.

Additionally, the system can enable the token generation neural network to generate the summary and the output conditioned on the summary in a single call to the neural network from a single input, thereby reducing the communication overhead between the entity and the token generation neural network. While the increase in overall output length can result in an increase in decoding time of the output sequence, the overall reduction in the number of inference calls required to generate a customized output can reduce the computational resources required for generating the output sequence.

Moreover, since the system trains the token generation neural network to generate the summary as a first subset of the output sequence of tokens and the output conditioned on the summary as a second subset of the same output sequence of tokens, the token generation neural network can be deployed to provide outputs in a streaming setting. In some cases, streaming outputs can reduce the latency required to provide the output to the entity, e.g., relative to generating the summary as a first output and then instructing the token generation neural network to generate the output conditioned on the summary.

In an example implementation described in this specification, the system can outperform existing customization training techniques by pairing supervised finetuning with iterative self-training. For example, a token generation neural network trained using the techniques of this specification can achieve improvements of up to 14.5% compared to supervised finetuning alone, and 6.5% compared to self-training alone on four benchmark long-form text personalization tasks using the LongLaMP (long-form language model personalization) dataset.

Furthermore, by using iterative self-training, the system can generate robust personalization training data using available ground truth output that can be used to optimize the token generation network to generate high-quality customized outputs. Since it is difficult to explore the space of possible candidate outputs without costly annotation, reinforcement learning for generating customized outputs that requires manually annotated data can be burdensome. Additionally, manually annotating the candidate summaries representing “correct” reasoning pathways is generally infeasible, e.g., since the ground truth rationale used to generate a particular customized output is generally not available without the input of the entity that provided the data. In contrast, the system of this specification can preclude the need to obtain a large volume of manually-annotated data for training by relying on implicit reasoning based on the generated summary.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a system diagram of an example inference system for generating a sequence of output tokens based on an input request and an entity input context.

FIG. 2 is a system diagram of an example training system for finetuning a token generation neural network.

FIG. 3A is a table showing example performance results of different training models on various long-form text personalization tasks.

FIG. 3B is a radar chart illustrating example performance comparisons.

FIG. 4 is a flow chart of an example process for training a token generation neural network to generate an output including a context summary and an output.

FIG. 5 is a flow chart of an example process for generating an output using a token generation neural network trained to generate outputs conditioned on input contexts for different entities.

Like reference numbers and designations in the various drawings indicate like elements.

### DETAILED DESCRIPTION

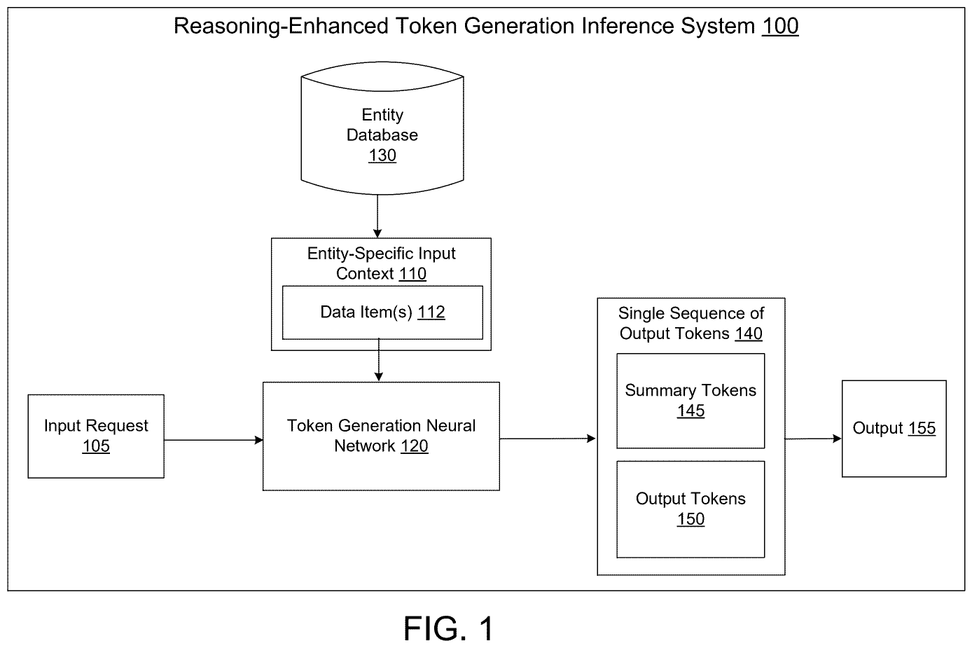

FIG. 1 shows an example reasoning-enhanced token generation inference system 100. The reasoning-enhanced token generation inference system 100 is an example of a system implemented as computer programs on one or more computers in one or more locations in which the systems, components, and techniques described below are implemented.

For example, the reasoning-enhanced token generation inference system 100 can be used to generate a customized output for an entity using a token generation neural network 120 that is conditioned on both an input request 105 and specific context related to the entity, e.g., the entity-specific input context 110. As an example, the entity can be a user, an organization, or a group of users. By pairing the request 105 with entity-specific context 110 tailored to the entity, the system 100 can generate outputs using a token generation neural network that are more personalized, relevant, and align more closely to the expectations of the entity relative to a system that generates outputs without conditioning on relevant entity-specific input context 110.

In this specification, a token generation neural network 120 is a machine learning model configured to generate a sequence of tokens, where each token in the sequence is generated based on the tokens that precede it. Token generation neural networks are trained to predict a probability distribution over a vocabulary of possible next tokens given a sequence of input tokens. An example token generation neural network will be described in more detail below.

The inference system 100 can obtain an input request 105 and an entity-specific input context 110.

The input request 105 can be a prompt, e.g., a directive instruction from the entity, requesting the system 100 generate an output to the request 105. In some cases, the system 100 can receive the request 105 from a client device associated with the entity, e.g., a user device.

In more detail, the entity-specific input context 110 can include data item(s) 112 that characterize the preferences and expectations of the entity, e.g., relative to the request or requests from the entity in general. The entity-specific input context 110 can include various types of data items, such as textual data items, visual data items, computer code data items, or audio data items. For example, the visual data items can be captured using an image sensor, e.g., a camera, and the audio data items can be captured using an audio sensor, e.g., microphone.

For example, the system 100 can obtain the entity-specific input context 110 by accessing an entity database 130 that maintains a repository of data items associated with the entity. More specifically, the system 100 can identify one or more data items 112 from the entity database 130 that are relevant to the input request 105 as the entity-specific input context 110. While depicted here as a database maintained by the system 100, in some cases, the entity database 130 can be maintained by a separate system, e.g., by another system that is accessible by the system 100 over a network. As an example, the entity database can be maintained on one or more user devices associated with the entity.

As another example, the system 100 can receive the entity-specific input context 110, e.g., from a user device associated with the entity. In this case, the entity, or another entity associated with the entity can select and provide data items 112 to the system 100 as the entity-specific input context 110.

In some cases, the system 100 can use a dense information retrieval model (not depicted) to identify the relevant data item(s) 112 from the entity database. More specifically, the system 100 can use a dense information retrieval model to identify the relevant data items 112 from the entity database 130 that are semantically relevant to the input request 105. For example, the dense information retrieval model can be a machine learning model specifically trained for information retrieval tasks, such as a Retrieval-Augmented Generation (RAG) model or a dual-encoder model, e.g., a Contriever model, e.g., as described in more detail with respect to Izacard, G., et. al. “Unsupervised Dense Information Retrieval with Contrastive Learning” Transactions on Machine Learning Research (August 2022) (arXiv:2112.09118v4).

In this case, the system 100 can process the input request 105 and the data items 112 in the database 130 to generate dense vector representations, e.g., embeddings of the input request 105 and each of the data items 112 within the entity database 130. The system 100 can then determine a similarity measure between the dense vector representations of the input request 105 and each of the data items 112 to identify the data items 112 that are most relevant to the input request 105.

As an example, in the case the system 100 uses a dual-encoder model to retrieve data items from the database 130, the embeddings can be generated in a shared high-dimensional embedding space, e.g., to facilitate comparison of the embeddings in the same embedding space. For instance, a dual-encoder model pretrained on a contrastive learning objective can learn to generate embeddings in a joint embedding space where related input requests and data items are located closer together in the embedding space relative to unrelated data items, thereby allowing the system 100 to identify semantically pertinent data items for the entity-specific input context 110 based on the distance between the embeddings.

More specifically, in this case, the system 100 can process the input request 105 using a first encoder of the dual-encoder and the system 100 can process each of the data items in the database 130 using a second encoder of the dual-encoder. The system 100 can then determine the similarity measure between embeddings of the input request 105 and each data item in the database by determining the distance between the embeddings in the shared embedding space. For example, the system 100 can determine the distance between embeddings using Euclidean distance, cosine distance, or another appropriate distance metric.

The system 100 can then select the top N data items 112 that are most similar to the request 105 based on the similarity measure. For example, the system 100 can select the top N data items that are the closest based on the distance between the embedding of the request 105 and the embeddings of the data items in the embedding space.

The system 100 can process the input request 105 and the entity-specific input context 110 using a token generation neural network 120 to generate a sequence of output tokens 140.

In particular, the token generation neural network 120 can be an auto-regressive neural network that autoregressively generates an output sequence of tokens by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence. For example, the current input sequence when generating a token at any given position in the output sequence can include a context sequence and the tokens at any preceding positions that precede the given position in the output sequence. As a particular example, the current input sequence can include the context sequence followed by the tokens at any preceding positions that precede the given position in the output sequence. Optionally, the context and the current output sequence can be separated by one or more predetermined tokens within the current input sequence.

In some cases, the token generation neural network 120 can be an auto-regressive Transformer-based neural network that includes (i) a plurality of attention blocks (a block that applies an attention mechanism over a block input to generate a block output) that each apply a self-attention operation and (ii) an output subnetwork that processes an output of the last attention block to generate the score distribution.

The token generation neural network 120 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; “Gemini: A Family of Highly Capable Multimodal Models” (arXiv:2312.11805, 2025); and “Gemma 3 Technical Report” (arXiv:2503.19786, 2025).

In this case, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

For example, the token generation neural network 120 can be a language model neural network, i.e., an auto-regressive neural network that generates output sequences of tokens from a vocabulary, e.g., conditioned on a context sequence. In this case, the tokens in the vocabulary can be text tokens, such that the language model neural network maps a context sequence of text tokens to an output sequence of text tokens. As another example, the language model neural network can be a multi-modal neural network, with the tokens in the context sequence including tokens representing another data modality, e.g., images, videos, or audio, instead of or in addition to text tokens.

As another example, the token generation neural network 120 can be a visual language model (VLM) that can be configured to process an image or sequence of images in a video to generate an intermediate representation of the image and perform an image processing task. For example, the base network can be a contrastive language-image pre-training (CLIP) model, a vision transformer (ViT), a unified image-to-image translation (UNIT) model, or an attention generative adversarial network (AttnGAN).

In this case, the image processing task can involve generating an output that requires reasoning, e.g., spatio-temporal reasoning, to respond to a natural language query input, e.g., relating to a moving image (video). For example, such a query may require predictive reasoning (“what will happen next”), counterfactual reasoning (“what would happen in a different circumstance”), explanatory reasoning (“why did something happen”), or causal reasoning generally. For example, the image representation can be used to detect objects in the video frames and provide information relating to the detected objects in response to a query, e.g., a request for a prediction of a future event or state relating to one or more of the objects (e.g., “will objects X and Y collide?”), or a request for conditional or counterfactual information relating to one or more of the objects (e.g., “what event would [not] happen if object X is modified, moved or absent?”), or a request for analysis of the video frames to determine a property or characteristic of one or more of the objects (e.g., “how many objects of type Z are moving?”). The output may, for example, be in the form of a yes/no answer, or may define a probability distribution over a set of possible answers; or the response may define the location of an object. Such a base network can be used to predict whether or not two objects will collide, or how this may be avoided. The output may be used e.g., to provide a warning, to control motion of one or more of the objects, or both.

The sequence of output tokens 140 can include input summary tokens 145 and output tokens 150. The summary tokens 145 can represent a summary that characterizes how the data item(s) 112 in the context 110 relate to determining the customized output for the respective entity. As an example, the summary represented by the input summary tokens 145 for a request to generate an email can identify the entity's typical writing style (e.g., formal or informal), common phrases used, and preferred email format based on input context including past emails. As another example, the summary represented by input summary tokens 145 for a request to generate an abstract for an academic paper can identify key aspects of the user's academic writing style based on input context including previously written papers.

The token generation neural network 120 can generate input summary tokens 145 and output tokens 150 in a single call to the neural network. That is, the token generation neural network 120 can generate the input summary tokens 145 and the output tokens 150 in a single, continuous sequence of output tokens 140 during inference. More specifically, the token generation neural network 120 can generate the input summary tokens 145 and the output tokens 150 in a single decoding step of the neural network 120. Rather than performing two separate decoding steps to generate the summary tokens 145 and the output tokens 150, the token generation neural network 120 can generate the summary tokens 145 before the output tokens 150 in a single sequence of output tokens 140, e.g., the input summary tokens 145 can be included in a first subset of the sequence of output tokens 140 and the output tokens 150 can be included in a second, distinct, subset of the sequence of output tokens 140. Thus, the generation of the output tokens 150 is naturally conditioned on the summary tokens 145 due to the auto-regressive nature of the decoding process.

By generating the input summary tokens 145 and the output tokens 150 in a single call to the token generation neural network 120, the system 100 can guide the token generation neural network 120 using reasoning enhancement. That is, the system 100 can instruct the token generation neural network 120 to (i) generate the summary represented by the input summary tokens 145 and then (ii) generate the output represented by the output tokens 150 conditioned on that summary, all within a single sequence of output tokens 140. Furthermore, generating the summary 145 and output 150 tokens in the same sequence reduces the number of inference and decoding calls to the token generation neural network 120, which lowers latency and conserves computational resources compared to a multi-step process that would require separate calls for summarization and final output generation.

The system 100 can detokenize the output tokens 150 as the output 155 for the request 105. For example, the output 155 can be a personalized output that is customized for the entity based on the entity-specific input context 110. The system 100 can then provide the output 155 to a user associated with the first entity. In some cases, the system 100 can provide the output 155 to a client device that is associated with the entity, or a related entity.

As an example, when the entity is a user, the system 100 can provide the output 155 to the user. As another example, when the entity is an organization or a group of users, the system 100 can provide the output 150 to one or more the users of the entity. In another case, a different entity can use the token generation neural network 120 to generate the output conditioned by the context for the entity.

For example, the output 155 can be a textual response that is generated, e.g., according to the entity's interest, style and formatting preferences, and familiarity with topics relevant to the request based on the input context. As another example, the output 155 can be an image, audio, or visual output that is generated, e.g., according to the entity's preferences represented in the input context. As yet another example, the output 155 can be a multimodal output including a combination of textual, visual, or audio outputs.

As a further example, the output 155 can be computer code generated in a particular style. For example, an entity, such as a software development team, can use the system to, e.g., generate a new script, refactoring an existing block of code, or add documentation. In this context, the input context can include multiple computer code data items, such as relevant code snippets from a common codebase, along with a code style guide or other documentation that defines coding conventions, variable naming schemes, and architectural patterns for that entity.

This system 100 can be used improve the maintainability and consistency of the codebase by ensuring that generated code adheres to the entity's specific guidelines. Consequently, the system 100 enhance the ability of the entity that manages the codebase to monitor and integrate changes, ensuring that contributions remain compliant with the established style guide.

Generally, the system 100 can use the token generation neural network 120 as an entity-specific personalization or customization agent. For example, the system 100 can be used by multiple entities to generate personalized outputs. Thus, the system 100 can provide a customized response to an input request by generating a summary of the relevant context relative to the input request and generating the output based on the summary.

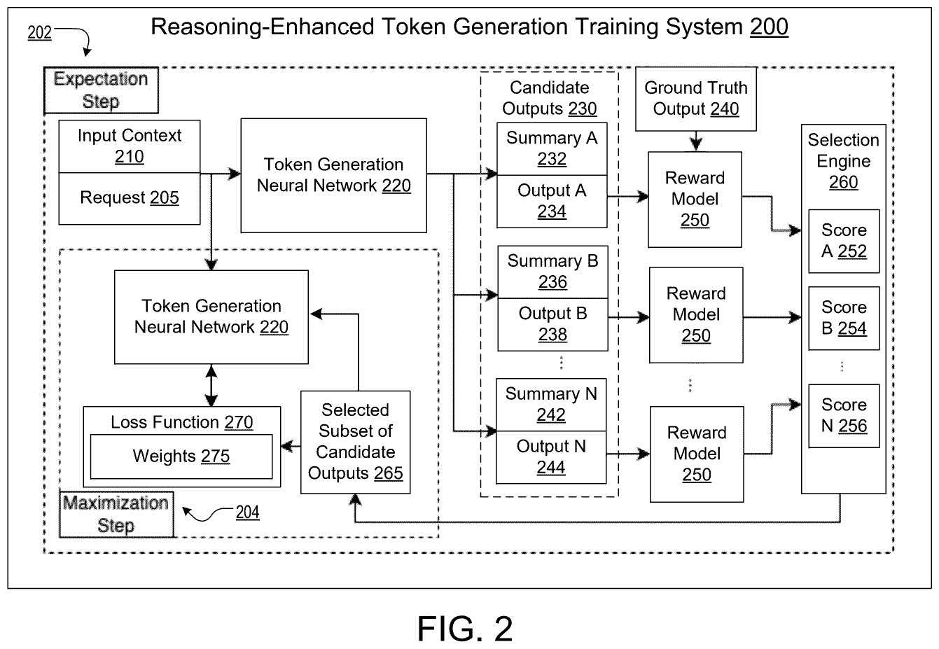

FIG. 2 shows an example reasoning-enhanced token generation training system 200. The training system 200 is an example of a system implemented as computer programs on one or more computers in one or more locations in which the systems, components, and techniques described below are implemented.

The reasoning-enhanced token generation training system 200 trains a token generation neural network 220, e.g., the token generation neural network 120 of FIG. 1, using an iterative self-training process. In this specification, “self-training” refers to a training process by which the system 200 generates the training data for training the token generation neural network 220, e.g., using the current version of the token generation neural network 220 as of the particular training iteration. In this specification, the self-training is referred to as “iterative self-training” because the system 200 performs multiple training iterations and, at each training iteration, improves the performance of the token generation neural network 220 so that the training data generated for the next training iteration is higher quality, e.g., where “quality” may be defined, e.g., by a quality score indicative of a similarity between a candidate output and the ground truth output for a training example.

For example, the system 200 can be used to train the token generation neural network 220 for content generation, e.g., customized text, visual, or audio content generation. In particular, a token generation neural network trained by the system 200 can be utilized by the entity as an entity-specific personalization agent, e.g., to draft emails, presentations, reviews, maintain a codebase, etc.

For illustrative purposes, the training process can be divided into an expectation step 202 and a maximization step 204, which can both be repeated as a training iteration for a set of one or more training iterations. The iterative self-training process allows the system 200 to refine the token generation neural network's 220 parameters over multiple training iterations, where each iteration uses higher-quality, model-generated data from the previous step to further improve performance.

The system 200 can obtain a training dataset that includes a number of training examples. Each training example can include a request 205, input context 210, and a ground truth output 240 for the request 205. As described with respect to FIG. 1., the request 205 can be a prompt, and the input context 210 can characterize preferences and expectations of an entity relative to the request 205. The ground truth output 240 can be a target output that includes a response to the request 205 for a particular entity. For example, the ground truth output 240 can be the entity's actual response to the request 205. In some cases, each of the training examples is obtained from a respective entity. In other examples, multiple training examples in the training dataset are obtained from respective entities.

While described below with respect to processing one training example during the expectation step 202, the system 200 can process one or more of the training examples to generate data for training the token generation neural network 220 during the maximization step 204.

During the expectation step 202, the system 200 can process an input including the request 205 and the input context 210 for a respective entity using the token generation neural network 220 to generate one or more candidate outputs 230 for the request 205. Each candidate output can include a candidate summary of the input context 210 and a candidate output conditioned on the candidate summary. In the particular example depicted, the system 200 has generated candidate output A including summary A 232 and output A 234, candidate output B including summary B 236 and output B 238, and so on, up through candidate output N including summary N 242 and output N 244.

As an example, a user of the system 200 can set the number of candidate outputs N that are generated for each training example. As another example, the system 200 can automatically determine the number of candidate outputs N that are generated for each training example, e.g., based on the size of the input context 210 or the computational resources available to the system 200 for processing the input.

For example, the system 200 can instruct the token generation neural network 220 to generate a candidate output for the request 205 based on the input context 210 using a prompt. More specifically, the system 200 can instruct the token generation neural network 220 using different variations of the prompt: “Generate a [response] to the [request] using the [input context]”. As an example, the system 200 can instruct the token generation neural network 220 on an academic paper abstract generation task using “Generate an abstract for the title “Reasoning about the Impacts of Information Sharing.” using the following items: decision process, communication graph, utility maximization, trust, information propagation.” As another example, the system can instruct the token generation neural network 220 on a product review task using: “Generate a product review for a reviewer who has given an overall rating of “5.0” for a product with description ‘The HL-5370DWT is a monochrome laser printer for offices or small workgroups. It offers a fast print speed of up to 32 ppm and produces crisp, high-quality output at up to 1200×1200 dpi resolution. The HL-5370DWT features built-in wireless and Ethernet network interfaces for sharing on your network and automatic duplex printing for two-sided documents', where the reviewer is especially pleased with the product for home use.”

As described with respect to FIG. 1, the token generation neural network 220 can generate a sequence of output tokens including candidate summary tokens and candidate output tokens. The token generation neural network 220 can be used to generate multiple outputs from the same input, e.g., the request 205 and the input context 210, by using a sampling method to generate multiple output sequences representing distinct candidate outputs, e.g., distinct summaries and distinct outputs.

More specifically, to generate a particular token at a particular position within an output sequence, the token generation neural network 220 can process the current input sequence to generate a score distribution, e.g., a probability distribution, that assigns a respective score, e.g., a respective probability, to each token in the vocabulary of tokens. The token generation neural network 220 can then select, as the particular token at the particular position, a token from the vocabulary using the score distribution.

In this case, instead of greedily selecting the highest-scoring token for each token, the token generation neural network 220 can sample a token from the distribution. For example, the system 200 can use a combination of a specific decoding temperature and a nucleus sampling threshold to control the trade-off between output diversity and focus, thereby enabling the generation of multiple distinct candidate outputs from the same input. In some cases, the system 200 can be preconfigured with a nucleus sampling threshold and a corresponding decoding temperature.

For example, the token generation neural network 220 can use nucleus sampling to select the token from a dynamically sized set of the most probable tokens, e.g., tokens whose cumulative probability exceeds a certain threshold p. By sampling from this reduced set of possible tokens, nucleus sampling can avoid less likely or irrelevant tokens, which can enhance the coherence and quality of the generated outputs while still allowing for variability in the candidate output.

Generally, a higher decoding temperature increases the randomness of the probability distribution over potential next tokens, resulting in the selection of more diverse and creative output tokens with higher entropy by making the probability distribution more uniform. Conversely, a lower decoding temperature decreases the randomness of the probability distribution over potential next tokens, thereby making the generation process more deterministic, e.g., favoring the selection of tokens with higher probabilities and leading to more predictable outputs with lower entropy.

By sampling from the output distribution of the token generation neural network 220, e.g., using nucleus sampling and a decoding temperature greater than zero to determine the summary tokens and the output tokens, the system 200 can use the token generation neural network 220 to generate multiple, diverse candidate outputs.

The system 200 can use a reward model 250 to determine a quality score for each of the generated candidate outputs 230. In the particular example depicted, the system 200 can use the reward model 250 to determine the quality score for each candidate output A, B, and C based on a measure of similarity between the candidate output and the ground truth output 240 from the training example.

For example, the reward model 250 can have any appropriate machine learning architecture, e.g., a neural network, that can be used to process the candidate output and the ground truth output to compute the quality score. For instance, the reward model 250 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

In some cases, the reward model 250 can be implemented as a token generation neural network, e.g., as the token generation neural network 220. In this case, the system 200 can instruct the reward model 250 to process an input including the request 205 and the ground truth output 240 to generate the quality score. In particular, the system 200 can instruct the reward model 250 to evaluate the quality of the candidate outputs compared to the ground truth output 240, e.g., using a prompt that defines scoring criteria. As an example, the scoring criteria can define different degrees of similarity between the ground truth output 240 and the candidate outputs.

Generally, the quality score does not depend on the candidate summary, e.g., Summary A 232, Summary B 236, and Summary N 242. In some cases, the quality score can be determined by comparing the candidate output and the ground truth output 240, without considering the candidate summary, since it is unlikely that a ground truth candidate summary is available. For example, the reward model 250 can compare Output A 234 with the ground truth output 240 to generate Score A 252. Similarly, the reward model 250 can compare Output B 238 and Output N 244 with the ground truth output 240 to generate Score B 254 and Score N 256, respectively.

The system 200 can use the quality scores 252, 254, and 256 to select a subset of the candidate outputs for training. For example, the subset can be a proper subset of the candidate outputs. In particular, the system 200 can use a selection engine 260 to select a subset of the candidate outputs based on the quality scores. For example, the selection engine 260 can select candidate outputs with respective quality scores that satisfy a threshold quality score.

More specifically, the system 200 can use the selection engine 260 to select the subset of candidate outputs 250 for optimizing the token generation neural network 220 in the maximization step 204. That is, the system 200 can steer the training process by selecting candidate outputs with the highest quality scores to progressively improve the generation of high-quality outputs in future training iterations.

During the maximization step, the system 200 can update one or more parameter values of the token generation neural network 220 using the selected subset of candidate outputs 265. While depicted here as the selected subset of candidate outputs 265 for one training example, the system 200 can generally update the token generation neural network 220 using respective selected subset(s) of candidate outputs for one or more training examples.

For example, the system 200 can determine a loss function 270 based on a discrepancy between the selected subset of candidate outputs 265 and the corresponding ground truth output for the subset 265, e.g., by aggregating the discrepancies between each candidate output in the subset 265 and the corresponding ground truth output. As an example, the loss of each candidate output can be determined using a sequence-to-sequence loss, e.g., using the loss function described in Sutskever, I., et. al. “Sequence to Sequence Learning with Neural Networks” (arXiv:1409.3215, 2014).

In some cases, the loss function 270 can be a weighted loss function. In this case, the system 200 can apply weights 275 to the loss of each candidate output, e.g., the system 200 can apply importance weights for each candidate output to the discrepancy determined for each candidate output in the selected subset of candidate outputs 265 as a scaling factor, e.g., the system can determine the loss function 270 as:

$${L}_{Total} ( θ ) = {\sum }_{i = 1}^{y} - {w}_{y} {ℓ}_{θ , y}$$

where [symbol] _{θ,y} is the loss determined for each candidate output (depending on network parameterization θ at the current iteration) and w_{y} is the weight applied to the loss for each candidate output y.

In some cases, the weight w_{y} for each candidate output can correspond with the quality score for the candidate output. As an example, the system 200 can apply a weight to each discrepancy term of the loss function 270 corresponding with a particular candidate output based on the quality score for that candidate output, e.g., the w can be the quality score: w_{y}=q(y, ŷ), where q is the quality score, y is the candidate output, and ŷ is the ground truth output. For example, in the case that the selection engine 260 selects a subset that includes all of the generated candidate outputs in the subset 265, the system can enhance the importance of the high quality outputs by weighting the loss function 270.

The system 200 can update one or more parameter values of the token generation neural network 220 to minimize the loss function 270. For example, the system 200 can update all of the parameter values of the token generation neural network 220, or some of the parameter values of the token generation neural network 220. In some cases, the system 200 can freeze a portion of the neural network, e.g., can hold the parameter values of the portion constant, and can update the parameters of the unfrozen portion of the neural network. In particular, the system 200 can update the parameter values of one or more specific layers of the token generation neural network 220, while holding the parameter values of the frozen layers of the token generation neural network 220 constant.

After updating one or more parameter values of the token generation neural network 220, the system 200 can process one or more training examples with the updated token generation neural network 220 to generate one or more candidate outputs 230 in a next expectation step, e.g., for use in the corresponding next maximization step. Thus, the system 200 can steer the training of the token generation neural network 220 to generate higher-quality outputs using a self-training process that improves the quality of the training data for each training iteration.

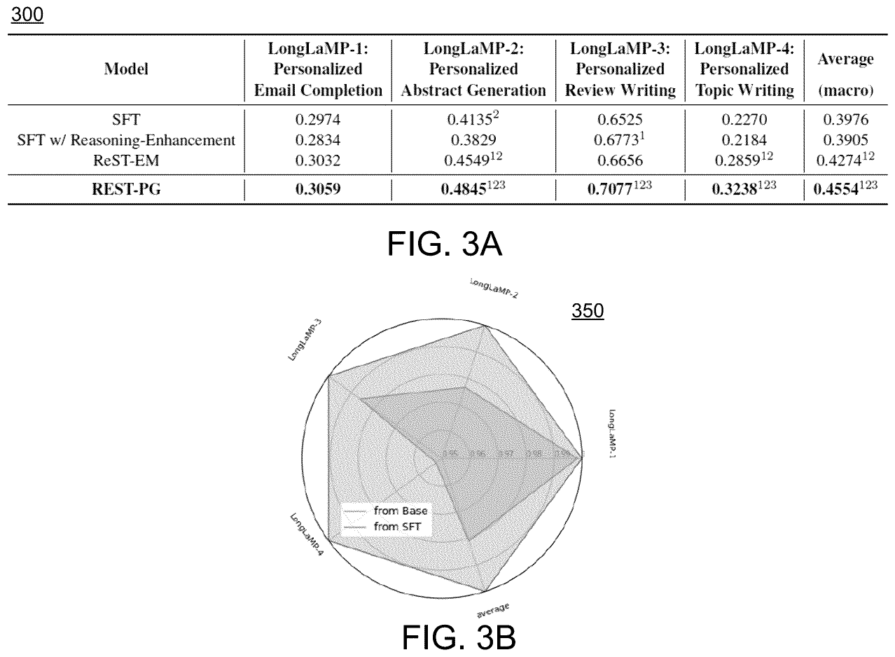

In some cases, instead of updating the token generation neural network 220 with parameter values determined in a previous iteration during the maximization step 204, the system 200 can update one or more parameter values of the token generation neural network 220 from a baseline model, e.g., the token generation neural network 220 that was used in the first self-training iteration. In more detail, the system 200 can use the token generation neural network 220 to generate increasingly higher-quality outputs in the expectation step 202, but can re-initialize the parameter values of the token generation neural network 220 for the maximization step 204 from the baseline model in each training iteration. An example of updating the parameter values of the token generation neural network from a baseline model will be described in more detail with respect to FIG. 3B.

While not depicted in the self-training loop, in some cases, before using iterative self-training as described in steps 202 and 204, the system 200 can perform supervised finetuning of the token generation neural network 220 using a set of examples to enable the token generation neural network 220 to generate the summary of the input context based on the ground truth output, and the output in a single decoding step. For example, prior to training, the token generation neural network 220 can be a foundational model, and the system 200 can finetune the token generation neural network 220 in a first training iteration 220 to generate the candidate summary and the candidate output conditioned on the candidate summary in a single decoding step. Generally, the set of examples used for supervised finetuning can be a different set of examples than the set of examples used to further train the token generation neural network 220, e.g., as described above.

The system 200 can finetune the token generation neural network 220 to generate the candidate summary and the candidate output conditioned on the candidate summary in a single decoding step by first generating a summary of relevant aspects of the input context, and then generating the candidate summary and the candidate output conditioned on the summary of relevant aspects. More specifically, the system 200 can use chain-of-thought prompting to instruct the token generation neural network 220 to interpret the user's interests, preferences, and familiarity with various topics from the input context 210 as a reasoning path, and then generate an output based on the reasoning path. For example, the system 200 can instruct the token generation neural network 220 to (i) generate one or more candidate summaries, each representing a reasoning path that explains how the ground truth output can be derived from the request and input context for the entity, and (ii) to generate the candidate output conditioned on the candidate summary, without considering the ground truth output.

In more detail, in a first step, the system 200 can guide the token generation neural network 220 to identify the aspects of the input context that are most relevant to generating the ground truth output as the summary. The system 200 can then, in a second step, instruct the token generation neural network 220 to generate the summary of the input context and generate the output conditioned on the summary.

The system 200 can compare the summary and the output generated in the second step with an expected output. In particular, the system 200 can combine the summary generated in the first step with the ground truth output as the expected output, e.g., the system 200 can concatenate the summary generated in the first step with the ground truth output as the expected output. The system can then finetune the token generation neural network 220 by updating one or more parameter values of the token generation neural network 220 based at least on the discrepancy between (i) the generated summary in the second step and the summary generated in the first step, and (ii) the generated output in the second step and the ground truth output.

In some cases, in the second step, the system 200 can instruct the token generation neural network 220 to generate multiple candidate outputs for each training example in the set of examples. That is, the system 200 can generate multiple summaries corresponding with different reasoning paths in the second step, and, since the token generation neural network conditions 220 the candidate output on the candidate summary, also resulting in diverse candidate outputs in the second step. In this case, despite the generation of more finetuning data, the system 200 can similarly finetune the token generation neural network 220 to generate candidate summaries and candidate outputs that more closely reflect the entities' preferences by updating the parameter values based on the summary generated based on the ground truth output in step one.

As an example of the two-step chain-of-thought prompting described above, the system 200 can first instruct the token generation neural network 220 to generate a customized output on a writing task by identifying the relevant aspects of the input context:
″″″″
#Your role: You are a professional writing assistant whose task is to summarize the writing style of a user from the profile, which is past documents written by that user. The extracted writing style summary should contain the unique features of users writing style and preferences from the profile that are similar to the expected output.
#Your task: Your task is to summarize the user writing style from the profile considering the expected output. From the profile, you may infer the user's interests, preference, familiarity on various topics, etc. While inferring the user's interests, you can make reasonable guesses, e.g. people who are interested in topic A are also likely to be interested in topic B or if they write a sentence in a specific writing style on topic A it is likely they write it with the same style on topic B. As a concrete example, if a user writes “I am interested in action movies” in its past document, this is relevant to “I like to go to cinema” in the expected output. Another example would be if a person prefers specific words or phrases in their writing or using a specific grammar. You can also mention such words that they often use in your summary.
#Your input:
profile: the past documents written by the same person that are separated with I symbol.
subject: the subject for the expected output.
expected output: the expected output written by the same person as the past documents.
#Your output: a list of bullet points and explanations describing writing style of the user. Also, make sure that you only talk about information from the profile while considering the expected output in writing style summarization. You cannot directly copy or mention anything about the expected output. The expected output is only used to determine the writing style of the user and how profile can affect the expected output.
#Examples
##profile: [data items from the user u's profile concatenated with “I” symbol]
##subject: [input prompt x for user u]
##expected output: [expected output y for user u]
″″″″″

Continuing with the same example, as the second part of the chain-of-thought prompting, the system 200 can instruct the token generation neural network 220 to generate a customized output on the writing task described in the prompt above by generating the output conditioned on the relevant aspects using the prompt:
“The following context includes data items written by a specific user. Please use the following context to generate a personalized response to the instruction. your response should follow the same pattern in terms of preferences and writing style in the provided context. You should first summarize the writing style of the user based on the provided context. Then, you should use the summarized writing style to generate a response to the instruction.”

As described above, the system 200 can then finetune the token generation neural network 220 using the output of the first and second prompts. That is, the system 200 can determine the discrepancy between (i) the generated summary in the second step and the summary generated in the first step, and (ii) the generated output in the second step and the ground truth output, and can update one or more values of the set of parameters of the token generation neural network 220 based at least on the discrepancy. More specifically, the system 200 can update parameter values of the token generation neural network 220 based on the expected output, e.g., the candidate summary generated using the ground truth output in the first step and the ground truth output.

In the case that the system 200 performs supervised finetuning of the token generation neural network 220 before self-training the token generation neural network 220, after supervised finetuning is complete, the system 200 can perform steps 202 and 204, respectively, in one or more training iterations.

By generating multiple candidate outputs and using a reward model to determine a quality score, the system 200 can select a high-quality subset for training, or, in some cases, further training of, the token generation neural network 220. Training on high-quality examples can decrease the number of training iterations necessary to reach convergence, e.g., compared to training with all generated outputs, some of which may not reflect the user's implicit preferences as represented by the input context 210, thereby reducing the use of computational resources required to provide a model for inference.

Thus, the system 200 can steer the token generation neural network 220 toward generating customized outputs that align with an entity's implicit preferences, as reflected in the ground truth output by instructing the token generation neural network 220 to generate the candidate summary and candidate output in a single call to the token generation neural network 220. Furthermore, by training the token generation neural network 220 to generate both a summary and an output in a single output sequence, the system 200 can be deployed to stream outputs to a user device. In this context, streaming outputs to a user device refers to transmitting each output token of the output sequence as it is decoded to the user device, rather than waiting for the entire output to be fully generated. By training the token generation neural network 220 to generate the summary and the output in a single output sequence, the system 200 can reduce the latency of providing a streamed output to a user device relative to approaches that require separate inference calls for reasoning and for generating the final output.

FIG. 3A is a table 300 showing example performance results of different training techniques on various long-form text personalization tasks.

The table 300 compares four models that were finetuned for performing a customization task: “SFT,” “SFT w/Reasoning-Enhancement,” “ReST-EM,” and “REST-PG” across four tasks from the LongLaMP benchmark. In this context, the “SFT” model has been trained using supervised finetuning with retrieval augmentation, e.g., using the techniques described with respect to Salemi, A., et. al. “LaMP: When large language models meet personalization. Proceedings of the 62nd Annual Meeting of the Association for Computational Linguistics, Volume 1: pages 7370-7392, and Kumar, I., et. al “Longlamp: A benchmark for personalized long-form text generation” (arxiv:2407:11016). The “SFT w/Reasoning-Enhancement” model has been trained using the supervised finetuning process described with respect to FIG. 2. The “ReST-EM” model has been trained using Expectation-Maximization Reinforced Self-Training without the reasoning enhancement, e.g., as is described in Singh, A. “Beyond human data: Scaling self-training for problem-solving with language models” Transactions on Machine Learning Research. The “REST-PG” model has been trained using the combination of supervised finetuning and iterative self-training processes, also described with respect to FIG. 2.

The values in the table 300 represent performance scores, with a higher score indicating better performance based on the alignment (e.g., preference similarity) between a generated output and a ground truth output. The results in the table 300 demonstrate that the “REST-PG” model consistently achieves the highest scores across most individual tasks and has the highest average score (0.4554) compared to the other models. For example, in the “Personalized Email Completion” task, the SFT model achieves a score of 0.2974, while the REST-PG model achieves a higher score of 0.3059. Similarly, for the “Personalized Abstract Generation” task, the SFT model has a score of 0.4135, while the REST-PG model scores 0.4845.

The high performance of the “REST-PG” model indicates that training a token generation neural network using the supervised finetuning and self-training processes described can result in high performance on personalization tasks, and superior performance with respect to the other models shown.

FIG. 3B is a radar chart 350 illustrating example performance comparisons between iterative self-training from a baseline model (“from Base”) and iterative self-training from a model that has been finetuned using the supervised finetuning process described with respect to FIG. 2 (“from SFT”).

In more detail, the radar chart 350 depicts performance across the four LongLaMP tasks for the self-training process described with respect to FIG. 2. In this context, the “from SFT” model refers to training in a next iteration of the maximization step using the model updated in the previous iteration, and the “from Base” model refers to continuing training in the next iteration of the maximization step from a baseline model, e.g., with parameter values determined before the first self-training training iteration. That is, in the maximization step, the system can update the parameter values of the token generation neural network from either (i) the parameter values of a baseline model, or (i) the parameter values of the finetuned model from the previous maximization iteration. In either case, as described with respect to FIG. 2, the updated token generation neural network can be used to generate increasingly higher-quality outputs in the expectation step.

The chart 350 demonstrates that training the token generation neural network “from Base” in the maximization step generally achieves higher relative performance across all tasks and on the average metric compared to the model trained “from SFT”. For example, for the LongLaMP-2, LongLaMP-3, and LongLaMP-4 datasets, the “from Base” line is further from the center than the “from SFT” line, indicating superior performance.

The chart 350 suggests that initializing the maximization step of the reinforced self-training process from a baseline set of parameters can be more effective than continuing from the finetuned set of parameters in the context of long-form text generation. More specifically, starting from the base model in each training iteration can allow the token generation neural network to learn the reasoning paths more freely, e.g., without being constrained by patterns learned during a previous training iteration.

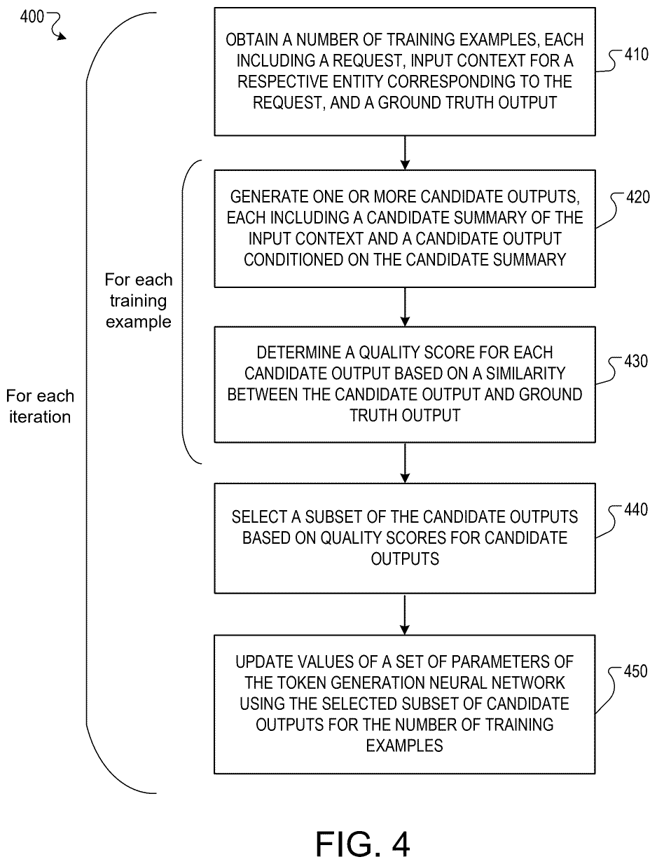

FIG. 4 is a flow chart of an example process 400 for training a token generation neural network to generate an output including a context summary and an output. For convenience, the process 400 will be described as being performed by a system of one or more computers located in one or more locations. For example, a training system, e.g., the reasoning-enhanced token generation training system 200 of FIG. 2, appropriately programmed in accordance with this specification, can perform the process 400.

At each of a set of one or more training iterations, the system can obtain a number of training examples (step 410). Each training example includes a request, an input context for a respective entity corresponding to the request, and a ground truth output for the respective entity. In particular, the ground truth output can be a personalized output customized for the entity. In some cases, the training examples can be associated with different entities. For example, each respective training example or one or more of the training examples can be associated with a respective different entity.

In some cases, obtaining the number of training examples can involve accessing a repository of entity data items that are associated with one or more respective entities. In this case, the system can identify k data items relevant to each request in the training example as the input context for the request. The input context can include a variety of data items, e.g., depending on the type of request. As an example, the input context can include one or more of textual data items, visual data items, computer code data items, or audio data items. In some cases, the computer code data items can each be selected from a common codebase.

For example, the k data items can be identified from the repository using a dense information retrieval model, e.g., a retrieval-augmented generation (RAG) model. In this case, the dense information retrieval model can process a request and the data items in the repository for a respective entity to generate respective dense vector representations, e.g., embeddings, that can be used to identify the k data items in the repository that have embeddings that are most similar to the embedding of the request based on a similarity score. As an example, the similarity score can be a cosine similarity score.

For each of the number of training examples, the system can generate one or more candidate outputs using the token generation neural network (step 420). For example, the token generation neural network can be a language processing neural network or a vision language model.

In particular, the system can process an input including the request and the input context for each training example to generate one or more candidate outputs for the training example. Each candidate output can include a candidate summary of the input context and a candidate output conditioned on the candidate summary. The output can be, for example, a long-form text output, a visual output, an audio output, or a multimodal output including one or more of a textual, visual, or audio output.

In this context, a candidate summary can refer to a description of the input context that summarizes the importance of the elements of the input context, e.g., the data items, when determining the customized output for the respective entity. In some cases, the candidate outputs can be candidate personalized outputs for a particular entity. In this case, the token generation neural network is utilized as an entity-specific personalization agent for the particular entity.

In more detail, each candidate output can include a sequence of output tokens generated by the token generation neural network. For example, the system can generate the one or more candidate outputs by processing the request and the input context using the token generation neural network at a first decoding temperature with an instruction to generate the candidate summary and the candidate output conditioned on the candidate summary. In this context, a decoding temperature can be used to control the randomness of the output generated using the token generation neural network. In some cases, the system can use nucleus sampling to select the sequence of output tokens at the first decoding temperature.

The system can determine a quality score for each of the one or more candidate outputs for each of the training examples (step 430). In particular, the quality score can be based on a similarity between the candidate output and the ground truth output in the training example. For example, the system can determine the quality score for each candidate output by processing a scoring input including the candidate output and the ground truth output using a quality model. In some cases, the scoring input can also include an instruction to evaluate a measure of similarity between the candidate output and the ground truth output. The quality model can be the token generation neural network itself or an additional token generation neural network.

In some cases, the quality score does not depend on the candidate summary, e.g., the system can determine the quality score based on the candidate output and the ground truth output, without using the candidate summary as a criterion for determining the quality score.

The system can select a subset of the candidate outputs for each of the training examples based on the quality scores (step 440). For example, the system can select the subset of candidate outputs with respective quality scores that satisfy a threshold. As an example, the system can select N candidate outputs with respective quality scores that satisfy the threshold, e.g., N can be 3, 5, or 10 candidate outputs.

The system can then update values of a set of parameters of the token generation neural network using the selected subset of candidate outputs for each of the number of training examples (step 450). For example, the system can train the token generation neural network by a machine learning training technique to optimize an objective function.

For example, for each training example, the system can determine a respective discrepancy between each candidate output in the selected subset of candidate outputs for the training example and the ground truth output. In some cases, the respective discrepancies can measure a sequence-to-sequence loss over respective output tokens corresponding with each candidate output and ground truth tokens corresponding with the ground truth output. For each training example, the system can generate a respective training example discrepancy by aggregating the respective discrepancies for each candidate output in the selected subset of candidate outputs. In some cases, aggregating the respective discrepancies can involve generating respective weighted discrepancies by applying an importance weight to the discrepancy for each candidate output in accordance with its corresponding quality score, and then aggregating these weighted discrepancies.

The system can then aggregate the respective training example discrepancies to generate a training iteration discrepancy. The system can use the training iteration discrepancy to update values of the set of parameters of the token generation neural network. In particular, the training iteration discrepancy can be included as a loss term in the objective function. The system can train the token generation neural network by calculating and backpropagating gradients of the objective function to update parameter values of the token generation neural network, e.g., using the update rule of any appropriate gradient descent optimization algorithm.

The process 400 can be performed over a number of iterations, e.g., using the values of the set of parameters of the token generation neural network that were determined at the preceding iteration. That is, for each iteration after a first iteration, the steps 410-440 can be performed using the token generation neural network that was updated in the preceding iteration. The system can either perform step 450 using the token generation neural network that was updated in the preceding iteration, or using a baseline token generation neural network, e.g., that was not updated in the previous iteration, as is described with respect to FIG. 3B.

In some cases, the process can further include a preliminary training stage at a first iteration. The preliminary training stage can involve supervised finetuning of the token generation neural network.

In this case, for each of the number of training examples at each of a second set of iterations, the system can generate a first summary that characterizes how the input context relates to generating an output to the request by processing the request, input context, and ground truth output using the token generation neural network with an instruction to identify relevant aspects of the input context, e.g., for generating the output based on the ground truth output. In particular, the second set of iterations can be performed as part of the preliminary training stage, e.g., before steps 410-450.

In this case, the first summary and the ground truth output can be combined as the expected output for each training example. The system can then generate a second summary of the input context and an output conditioned on the second summary by processing the request and input context with instructions to generate the second summary and to generate the output without considering the ground truth output.

During this preliminary training stage, the system can update the values of the set of parameters of the token generation neural network using the generated outputs and the corresponding expected outputs. For example, the system can update the values of the set of parameters of the token generation neural network in accordance with minimizing a first discrepancy between the generated second summaries and the first summaries, and a second discrepancy between the generated outputs and the ground truth outputs for each training example.

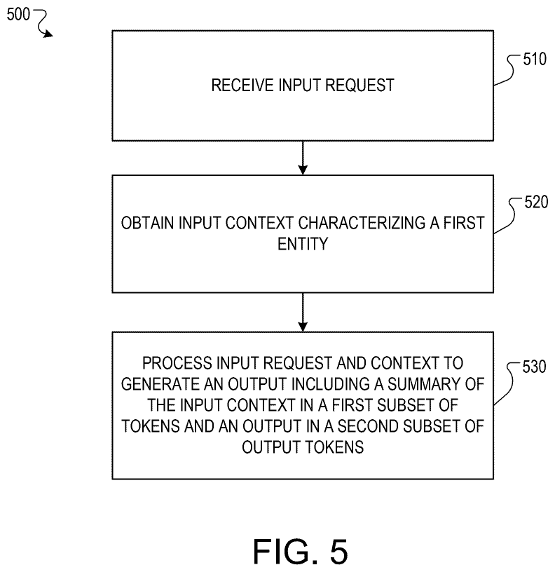

FIG. 5 is a flow chart of an example process 500 for generating an output using a token generation neural network trained to generate outputs conditioned on input contexts for different entities. For convenience, the process 500 will be described as being performed by a system of one or more computers located in one or more locations. For example, an inference system, e.g., the reasoning-enhanced token generation inference system 100 of FIG. 1, appropriately programmed in accordance with this specification, can perform the process 500.

The system can receive an input request (step 510), and the system can obtain an input context characterizing a first entity (step 520). As an example, the system can obtain the input context for the first entity by receiving the input context for the first entity, e.g., from the first entity, or from an intermediary entity. As another example, the system can obtain the input context from a repository of first entity data items associated with the first entity.

The system can process the input request and the input context using a trained token generation neural network to generate an output conditioned on the input context for the first entity (step 530). For example, the token generation neural network can be a token generation neural network that has been trained using the method described with reference to FIG. 4.

As a related example, the token generation neural network can have been trained to generate a summary of the input context characterizing the first entity in a first subset of a sequence of output tokens prior to generating the output in a second subset of a sequence of output tokens. More specifically, the system can process the input request using the trained token generation neural network to generate a summary of the input context as a first subset of a sequence of output tokens and the output as a second subset of the sequence of output tokens. In this case, the token generation neural network generates the output by conditioning the output on the summary of the input context characterizing the first entity.

In more detail, the token generation neural network can have been trained using a number of training examples, e.g., training examples that do not include data from the first entity. For example, each training example can include (i) a training input including a respective input request and a respective input context characterizing an entity different from the first entity, and (ii) a training output comprising a respective summary of the input context characterizing the entity different from the first entity, and, subsequently, an output responsive to the input request. In some cases, for one or more of the training examples, the summaries of the input context can have been generated using a token generation neural network.

For example, the system can provide the output, e.g., to the first entity, or to another entity associated with the first entity. For example, the system can display the output to the first entity or a user associated with the first entity. In some cases, the summary of the input context characterizing the entity is not displayed to the first entity, e.g., the system provides the output conditioned on the input context without the summary that was generated to condition the output on the input context.

After training, the system or another inference system can deploy the trained token generation neural network for performing a machine learning task. In general, the above techniques can be used to implement and customize a wide range of machine learning tasks.

For example, in some implementations the token generation neural network may implement a sequence-to-sequence model that processes an input sequence of tokens to provide an output sequence of tokens, e.g., from a vocabulary of tokens. For example the tokens may comprise tokens representing text such as words or word pieces in a natural language, or values or acoustic features of an audio waveform, or values of pixels of a still or moving image (which as used herein includes points of a LIDAR point cloud). In some implementations the context input may comprise tokens representing observations of an environment, e.g., a real-world environment, of an agent, e.g., a mechanical agent, and the output example may include tokens that represent actions to be performed by the agent. In some implementations one or both of the context input and the output example comprise data in some other format. For example the context input may comprise an embedding of one or more of the aforementioned data types; and the output example may comprise data representing, e.g., text, audio, image pixels, or actions that is not tokenized.

Where the token generation neural network comprises a language model neural network the context input may represent a sequence of text in one language and the output example can be a translation of the sequence of text into another language, i.e., a sequence of text in the other language that is a translation of the input sequence of text. In some implementations the token generation neural network may be trained to perform a multilingual machine translation task, i.e., to translate between multiple different source language-target language pairs (in which case the context input may be augmented with an identifier that indicates the target language).

In some implementations the token generation neural network comprises a language model neural network models a computer language, e.g., an interpreted or compiled high level language, or a markup language, or machine code. The context input may represent a sequence of text in the computer language, i.e., computer code, e.g., a computer program, and the output example may represent a sequence of text in a natural language that describes the operation of the code; or the context input may represent a sequence of text in a natural language that specifies the operation of a computer program or other computer code, and the output example may represent a sequence of text in the computer language, i.e., computer code, that operates as specified.

In some applications the token generation neural network comprises an audio, image or video generation model or a multimodal model. The output example may then comprises one or both of audio data representing an audio waveform and image data representing pixels of a still or moving image. The context input may defines characteristics of the output example, e.g., describing the output example to be generated. For example the context input may comprise text in a natural language, e.g., as a sequence of tokens, that defines, e.g., describes, a target content of the output example such as an image, audio, or video to be generated. Or context input may comprise an image, audio, or video, and the output example may describe one or more characteristics of the context input.

Where the context input comprises text in a natural language the output example may comprise audio data that represents a spoken utterance of the text in the natural language. As another example, where the context input comprises audio data, e.g., a sequence of tokens, for a spoken utterance in a natural language the output example may represent text, e.g., as a sequence of tokens, that is a transcription of the spoken utterance in the natural language.

The token generation neural network may comprise a multimodal model that is configured to process a context input and/or generate an output example that includes data of multiple different types, e.g., two or more of data representing text in a natural language, audio, still or moving images, observations of an environment, and actions for an agent, e.g., represented as tokens as previously described. Such a multimodal model may, e.g., convert between different input and output modes, e.g., text/image/audio, e.g., for captioning, or otherwise classifying (into one of a set of classes) or characterizing an image or audio input, or by answering a question related to the image or audio input, e.g., relating to a future, e.g., a physical prediction of a state of objects represented by the image or audio, or by generating data representing an image or audio in answer to a text, audio, or visual question represented by the context input.

The token generation neural network may comprise a neural network configured to perform an agent control task.

For example, the context input may comprise data, e.g., tokens, that represent a sequence of one or more observations characterizing states of an environment, and the output example may comprise data that defines an action to be performed by the agent in response to the most recent data in the sequence.

As one example, the agent may be a mechanical agent, e.g., a robot, acting in a real-world environment to perform a task; the observations may comprise any type of observations, e.g., observations from one or more sensors of the environment, such as an image sensor or a sensor of a position, state or configuration of the agent. The output example may comprise control signals, e.g., tokens that represent control signals, used to control the agent to perform the task, e.g., to control position, velocity, or acceleration of the agent, e.g., for navigation, or of parts of the agent, e.g., for object manipulation. Optionally the context input may include other information, e.g., textual tokens for text defining the task to be performed. Such a task may be, e.g., to locate or manipulate an object of interest in the environment or to move an object of interest to a specified location in the environment or to navigate to a specified destination in the environment. In another example the agent may be a human agent and the actions may comprise instructions, e.g., actions that generate text, audio, and/or visual instructions, to the human to perform the task. For example a digital assistant may include one or more sensors such as a camera that capture observations of the human user, and can use the token generation neural network to generate actions in response to the observations, e.g., action tokens, that represent instructions to the user to perform a particular task, to guide the user through the task. The task may, e.g., be defined by text in a natural language in the context input, e.g., encoded as text tokens.

As another example, the agent may be a simulated agent acting in a simulated environment. That is, the environment may be a simulated environment, e.g., a video game or a simulator of a real-world environment, generated by one or more software programs and the agent may be a simulated agent interacting within the simulated environment.

As another example, the agent may be a computer control agent that controls one or more software applications executing on one or more computers. For example, the agent can perform actions that are commands for interacting with the one or more software applications. The software applications can be, e.g., applications on smartphones, tablets, or other mobile devices, applications on a different type of user computer, or application executing one on or more server computers. The commands can be, e.g., virtual input device commands, e.g., virtual mouse or keyboard commands, or calls to an application programming interface (API) or a combination of the two.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for training a token generation neural network to generate outputs conditioned on an input request and an input context characterizing a corresponding entity, the method comprising, at each of a set of one or more iterations:
obtaining a plurality of training examples for the iteration, each training example comprising a request, an input context for a respective entity corresponding to the request, and a ground truth output for the respective entity;
for each of the plurality of training examples,
generating, by processing an input comprising the request in the training example and the input context in the training example using the token generation neural network, one or more candidate outputs, each candidate output comprising a candidate summary of the input context and a candidate output conditioned on the candidate summary; and
determining a quality score for each of the one or more candidate outputs based on a similarity between the candidate output and the ground truth output in the training example;
selecting a subset of the candidate outputs based on the quality scores for the candidate outputs; and
updating values of a set of parameters of the token generation neural network using the selected subset of candidate outputs for each of the plurality of training examples.

2. The method of claim 1, wherein obtaining the plurality of training examples further comprises, for each training example:
accessing a repository of first entity data items that are associated with the respective entity corresponding to the requests; and
identifying k data items relevant to the request from the repository of first entity data items as the input context for the request.

3. The method of claim 2, wherein identifying k data items relevant to the request further comprises identifying the k data items using a dense information retrieval model.

4. The method of claim 1, wherein the input context comprises one or more of textual data items, visual data items, computer code data item, or audio data items.

5. The method of claim 1, wherein generating one or more candidate outputs using the token generation neural network comprises, for each of the plurality of training examples:
generating the one or more candidate outputs by processing the request and the input context using the token generation neural network at a first decoding temperature with an instruction to generate the candidate summary and the candidate output conditioned on the candidate summary.

6. The method of claim 1, wherein each of the one or more candidate outputs comprises a sequence of output tokens generated by the token generation neural network.

7. The method of claim 6, further comprising, for each candidate output:
using nucleus sampling to select the sequence of output tokens at the first decoding temperature.

8. The method of claim 1, wherein the quality score does not depend on the candidate summary.

9. The method of claim 1, wherein determining the quality score comprises:
generating a respective quality score for each candidate output by processing a scoring input comprising the candidate output and the ground truth output in the training example using a quality model.

10. The method of claim 9, wherein the quality model is the token generation neural network or a second token generation neural network, and wherein the scoring input further comprises an instruction to evaluate a measure of similarity between the candidate output and the ground truth output.

11. The method claim 1, wherein selecting the subset of the candidate outputs based on the quality scores comprises:
selecting the subset of candidate outputs with respective quality scores that satisfy a threshold.

12. The method of claim 11, wherein selecting the subset of the candidate outputs comprises selecting N candidate outputs with respective quality scores that satisfy a threshold.

13. The method of claim 1, wherein updating values of the set of parameters of the token generation neural network using the selected subset of candidate outputs comprises:
for each of the plurality of training examples, determining a respective discrepancy between each candidate output in the selected subset of candidate outputs for the training example and the ground truth output in the training example;
for each of the plurality of training examples, generating a respective training example discrepancy by aggregating the respective discrepancies for each candidate output;
generating a training iteration discrepancy by aggregating the respective training example discrepancies; and
updating the values of the set of parameters of the token generation neural network to minimize a loss function that comprises a first term that measures the training iteration discrepancy.

14. The method of claim 13, wherein generating a respective training example discrepancy by aggregating the respective discrepancies for each candidate output comprises:
generating respective weighted discrepancies by applying an importance weight to the discrepancy for each candidate output in accordance with the corresponding quality score for the candidate output; and
generating the training example discrepancy by aggregating the respective weighted discrepancies for each candidate output.

15. The method of claim 14, wherein the respective discrepancies measure a sequence-to-sequence loss over respective output tokens corresponding with each candidate output and ground truth tokens corresponding with the ground truth output.

16. The method of claim 1, wherein the set comprises a plurality of iterations, and wherein, for each iteration in the plurality of iterations after a first iteration, the generating one or more candidate outputs using the token generation neural network comprises generating one or more candidate outputs using values of the set of parameters of the token generation neural network determined at the preceding iteration.

17. The method of claim 1, further comprising, at a first iteration:
for each of the plurality of training examples at each of a second set of iterations,
generating a first summary by processing the request, the input context, and the ground truth output using the token generation neural network with an instruction to identify relevant aspects of the input context for the ground truth output;
combining the first summary and the ground truth output as an expected output for the training example;
generating, by processing an input comprising the request in the training example and the input context in the training example using the token generation neural network, a second summary of the input context and an output conditioned on the second summary with a (i) first instruction to generate the second summary for the first entity and (ii) a second instruction to generate the output conditioned on the second summary without considering the corresponding ground truth output; and
updating the values of the set of parameters of the token generation neural network using the one or more generated outputs and the corresponding one or more expected outputs for the plurality of training examples.

18. The method of claim 17, wherein updating the values of the set of parameters of the token generation neural network using the one or more generated outputs and the corresponding one or more expected outputs comprises:
updating the values of the set of parameters of the token generation neural network in accordance with minimizing a (i) first discrepancy between the respective generated second summaries and respective first summaries of the expected outputs and (ii) a second discrepancy between the respective generated outputs and the respective ground truth outputs of the expected outputs for each of the plurality of training examples.

19. A computer-implemented method of performing a machine learning task, comprising:
receiving an input request;
obtaining an input context for a first entity; and
processing the input request and the input context using a trained token generation neural network to generate an output conditioned on the input context for the first entity, wherein the token generation neural network has been trained by operations comprising, at each of a set of one or more iterations:
obtaining a plurality of training examples for the iteration, each training example comprising a request, an input context for a respective entity corresponding to the request, and a ground truth output for the respective entity;
for each of the plurality of training examples,
generating, by processing an input comprising the request in the training example and the input context in the training example using the token generation neural network, one or more candidate outputs, each candidate output comprising a candidate summary of the input context and a candidate output conditioned on the candidate summary; and
determining a quality score for each of the one or more candidate outputs based on a similarity between the candidate output and the ground truth output in the training example;
selecting a subset of the candidate outputs based on the quality scores for the candidate outputs; and
updating values of a set of parameters of the token generation neural network using the selected subset of candidate outputs for each of the plurality of training examples.

20. The method of claim 19, wherein obtaining the input context for the first entity comprises:
receiving the input context for the first entity; or
obtaining the input context from a repository of first entity data items associated with the first entity.

21. A computer-implemented method of performing a machine learning task, the method comprising:
receiving an input request;
obtaining an input context characterizing a first entity;
processing the input request and the input context using a token generation neural network to generate an output, wherein the token generation neural network has been trained to generate a summary of the input context characterizing the first entity in a first subset of a sequence of output tokens prior to generating the output in a second subset of a sequence of output tokens, and wherein the generation of the output by the token generation neural network is conditioned on the summary of the input context characterizing the first entity.
